(19) United States
(12) Patent Application Publication
(10) Pub. No.: US 2006/0119075 A1
(43) Pub. Date: Jun. 8, 2006

(54) Trailer ball and production thereof

(76) Inventor: Sharon Chen, Tai Ping City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/003,218

(22) Filed: Dec. 3, 2004

(51) Int. Cl. B60D 1/06

(52) U.S. Cl. 280/511

(57) ABSTRACT

A method is disclosed for making a trailer ball. The method includes a step of providing a block, a step of spheroidizing graphite in the block, a step of cold forging the block into a trailer ball. The trailer ball includes a disc, a ball formed on a side of the disc, a non-circular neck formed on an opposite side of the disc and a bolt extended from the non-circular neck. The bolt is tapped with a thread.

### BACKGROUND OF INVENTION

1. Field of Invention The present invention relates to a trailer ball and a method for making a trailer ball.

2. Related Prior Art FIG. 9 shows a flow chart of a conventional method for making a trailer ball. In step A, a metal block is provided. In step B, the metal bock is heated and therefore softened. In step C, the metal block is forged into a trailer ball. In step D, scrap is removed from the trailer ball. In step E, the bolt 5 is tapped with a thread 6. In step F, the trailer ball is made.

Referring to FIG. 10, the trailer ball includes a hexangular disc 2, a ball 1 formed on the top of the hexangular disc 2 and a bolt 5 extending from the bottom of the hexangular disc 2. A thread 6 is formed on the bolt 5. A board 3 is extended from a trailer (not shown). The board 3 includes a hexangular hole 4 defined therein and a circular hole 9 communicated with the hexangular hole 4. In use, the hexangular disc 2 of the trailer ball is fit in the hexangular hole 4 of the board 3. The bolt 5 is inserted through the circular hole 9. A washer 7 is provided between the board 3 and a nut 8 engaged with the bolt 5.

This conventional trailer ball includes a complicated fabrication and involves an inaccurate size and results in a high cost.

The present invention is therefore intended to obviate or at least alleviate the problems encountered in prior art.

### SUMMARY OF INVENTION

According to the present invention, a method is disclosed for making a trailer ball. The method includes a step of providing a block, a step of spheroidizing graphite in the block, a step of cold forging the block into a trailer ball. The trailer ball includes a disc, a ball formed on a side of the disc, a non-circular neck formed on an opposite side of the disc and a bolt extended from the non-circular neck. The bolt is tapped with a thread.

The primary advantage of the making method of the trailer ball according to the present invention is to provide a simple and inexpensive method for making the trailer with an accurate size.

Other objects, advantages, and novel features of the invention will become more apparent from the following detailed description when taken in conjunction with the drawings.

### BRIEF DESCRIPTION OF DRAWINGS

The present invention will be described through detailed illustration of the preferred embodiment referring to the drawings.

FIG. 1 is a flow chart of a method for making a trailer ball according to the preferred embodiment of the present invention.

FIGS. 2 to 5 are side views of a metal block in various steps in the method shown in FIG. 1.

FIG. 6 is a perspective view of the trailer ball.

FIG. 7 is a perspective view of the trailer ball shown in FIG. 6 about to be installed on a board.

FIG. 8 is a perspective view of the trailer ball installed on the board shown in FIG. 7.

FIG. 9 is a flow chart of a conventional method for making a trailer ball.

FIG. 10 is a perspective view of the trailer ball shown in FIG. 9 about to be installed on a board.

### DETAILED DESCRIPTION OF PREFERRED EMBODIMENT

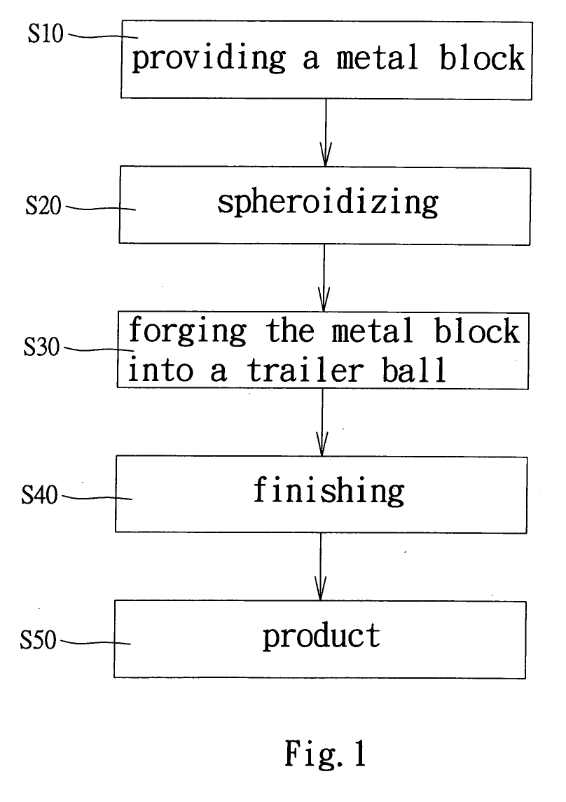

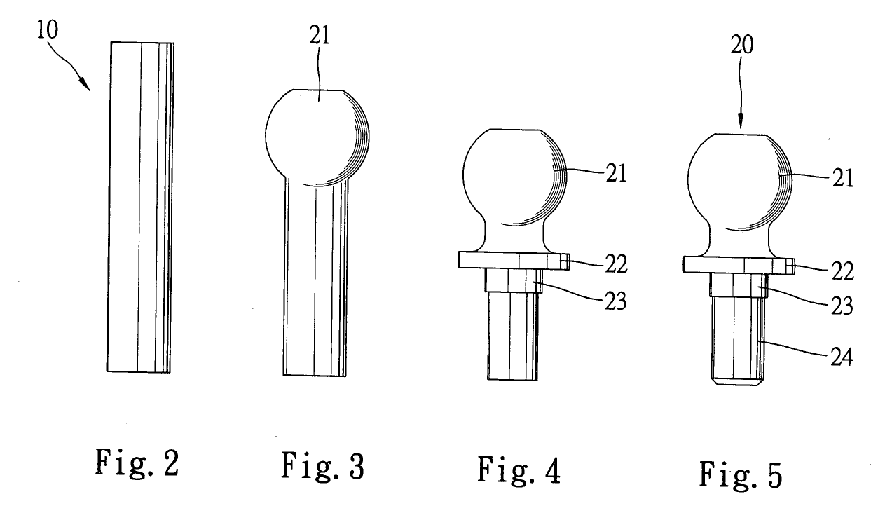

Referring to FIG. 1, according to the preferred embodiment of the present invention, a flow chart of a method for making a trailer ball 20 is shown. In step S10, a block 10 is provided. The block 10 is made of low-carbon steel. In step S20, the block 10 undergoes a spheroidizing process in order to transform graphite in the block 10 to a spheroid configuration from a flat configuration. In step S30, the block 10 is pressed so as to form the trailer ball 20. Referring to FIG. 2, the block 10 is in the form of a rod is provided. Referring to FIG. 3, a ball 21 is formed. Referring to FIG. 4, a disc 22 and a non-circular neck 23 are formed. In step S40, a bolt 24 is formed. The bolt 24 is tapped with a thread (not numbered) referring to FIG. 5. The trailer ball 20 is polished and/or plated in order to get a pleasing look.

In step S50, the trailer ball 20 is made.

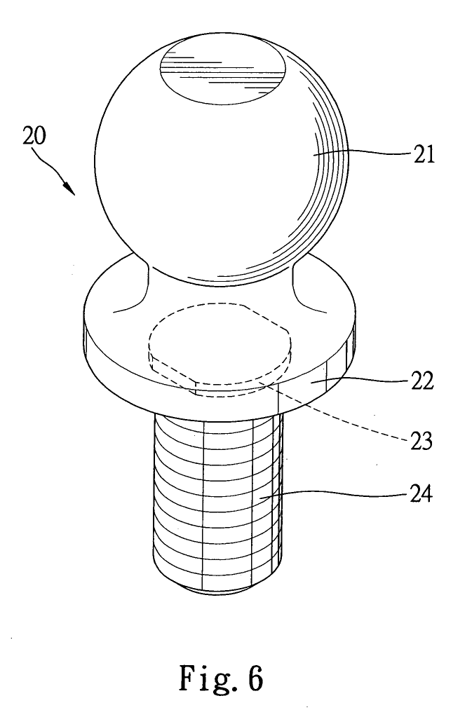

Referring to FIG. 6, the trailer ball 20 includes a disc 22, a ball 21 formed on the top of the disc 22, a non-circular neck 23 formed on the bottom of the disc 22 and a bolt 24 extending from the non-circular neck 23.

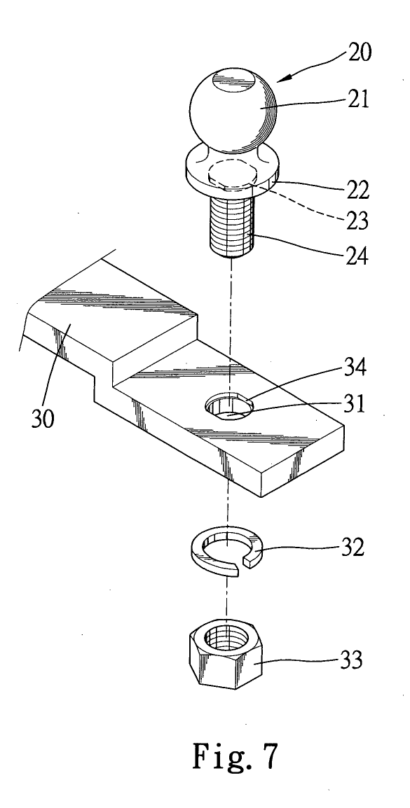

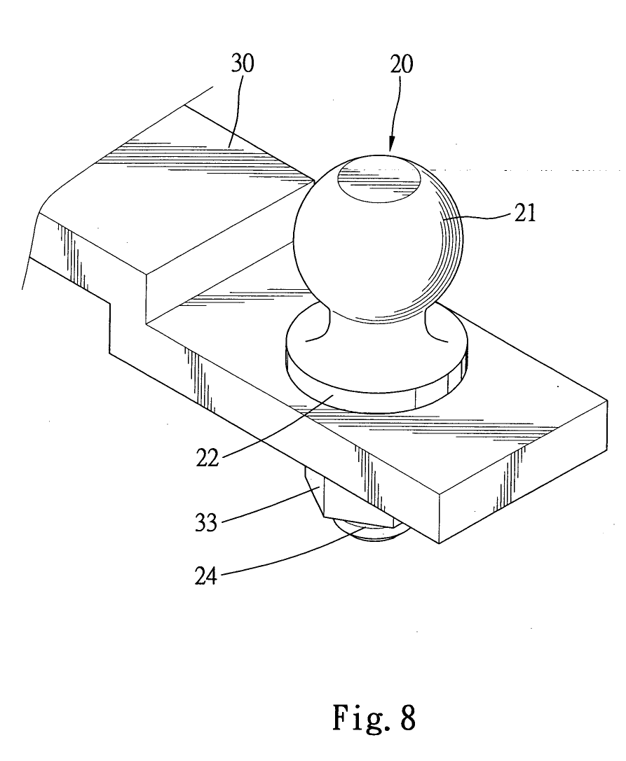

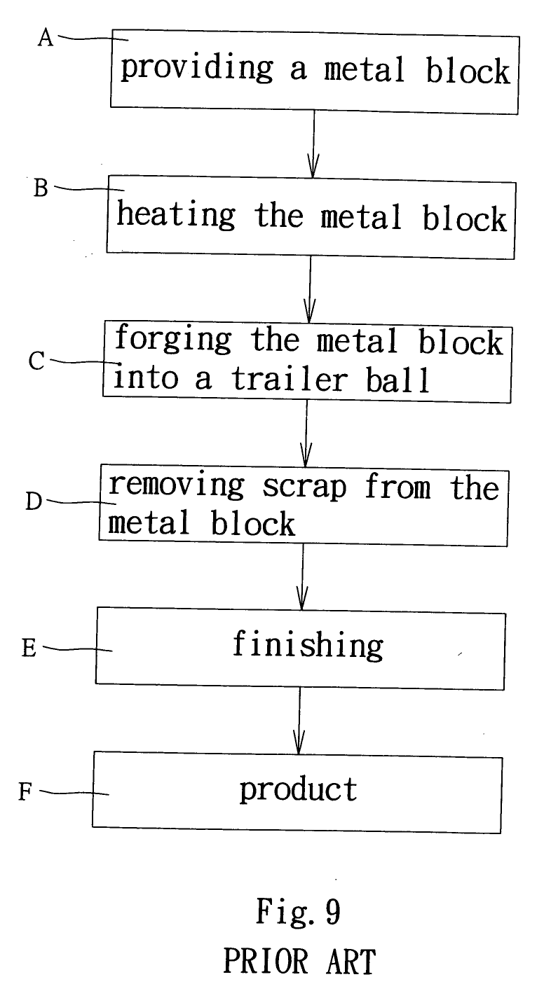

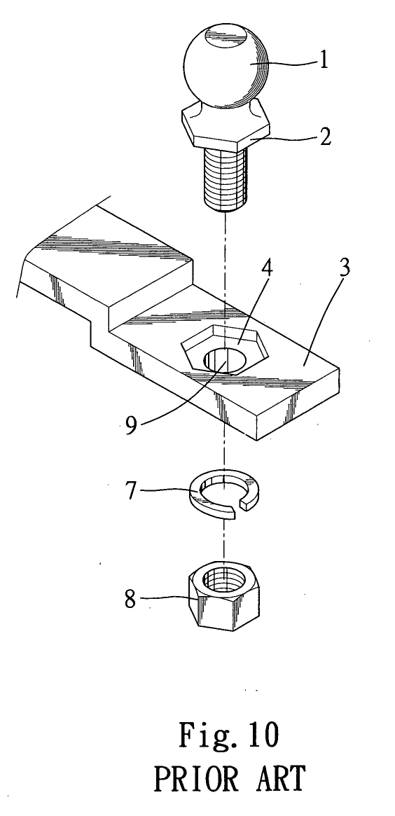

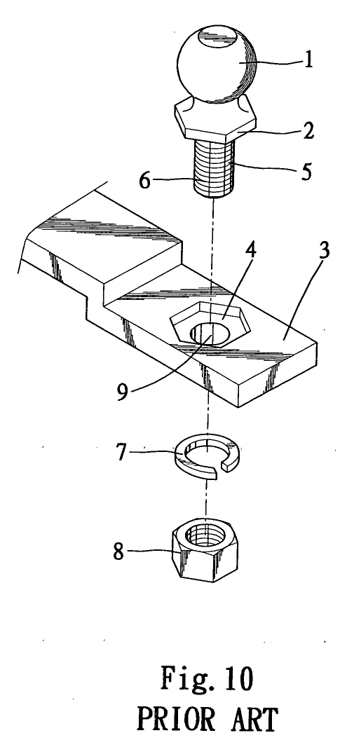

Referring to FIGS. 7 and 8, the trailer ball 20 is installed on a board 30 connected with a trailer (not shown). The board 30 includes a non-circular hole 34 defined therein and a circular hole 31 communicated with the non-circular hole 34. The non-circular hole 34 is larger than the circular hole 31 so that the bolt 24 can easily be inserted into the circular hole 31 through the non-circular hole 34. The non-circular hole 34 matches the non-circular neck 23. Thus, the trailer ball 20 is installed on the board 30 in a non-rotational manner. A bolt 24 is inserted through the non-circular hole 34 and the circular hole 31. A washer 32 is provided between the board 30 and a nut 33 engaged with the bolt 24.

The method for making the trailer ball 20 according to the present invention adopts a cold forging process. No heat is needed, thus saving a lot of energy. In addition, the metal block 10 does not undergo heating and cooling, i.e., it does not expand when heated and shrink when cooled. Therefore, its volume is exactly the volume of the trailer ball 20, thus eliminating scrap that always occurs in a hot forging process as discussed in Related Prior Art. Hence, the size of the trailer ball 20 made in the method according to the present invention is accurate.

The present invention has been described through detailed illustration of the preferred embodiment. Those skilled in the art can derive variation from the preferred embodiment without departing from the scope of the present invention. Therefore, the preferred embodiment shall not limit the scope of the present invention defined in the claims.

1. A method for making a trailer ball, the method comprising:
a step of providing a block;
a step of spheroidizing the block in order to transform graphite in the block to a spheroid configuration from a flat configuration;
a step of cold forging the spheroidized block into a trailer ball comprising a disc, a ball formed on a side of the disc, a non-circular neck formed on an opposite side of the disc and a bolt extended from the non-circular neck; and
a step of tapping the bolt with a thread.

2. The method for making a trailer ball according to claim 1 wherein the block is made of low-carbon steel.

3. The method for making a trailer ball according to claim 1 comprising a step of polishing the trailer ball in order to get a pleasing look.

4. The method for making a trailer ball according to claim 1 comprising a step of plating the trailer ball in order to get a smooth surface.

5. A trailer ball comprising a disc, a ball formed on a side of the disc, a non-circular neck formed on an opposite side of the disc and a bolt extended from the non-circular neck.
